(19) United States
(12) Patent Application Publication
(10) Pub. No.: US 2002/0126132 A1
(43) Pub. Date: Sep. 12, 2002

(54) Targeted force application in clothing simulations

(76) Inventors: Harry Karatassos, Cranberry Township, PA (US); William R. Ommert, Pittsburgh, PA (US)

Correspondence Address: WEBB ZIESENHIM LOGSDON, ORKIN & HANSON, P.C., 700 Koppers Building, 436 Seventh Avenue, Pittsburgh, PA, 15219-1818, US

(21) Appl. No.: 10/058,478

(22) Filed: Jan. 24, 2002

Related U.S. Application Data
(60) Provisional application No. 60/263,963, filed on Jan. 24, 2001.

(51) Int. Cl. G09G 5/00

(52) U.S. Cl. 345/586

(57) ABSTRACT

Disclosed is a programmatic use of targeted forces to reduce non-realistic effects in simulating clothing on a body. These forces are applied adaptively to instances of clothing-body and clothing-clothing interaction to compensate for behavior of the simulation system that produces effects that do not reflect the actual look of a person wearing that article of clothing.

### CROSS REFERENCE TO RELATED APPLICATION

This application claims the benefit of United States Provisional Application Serial No. 60/263,963 filed Jan. 24, 2001.

### BACKGROUND OF THE INVENTION

1. Field of the Invention

The present invention is related to computerized simulation and modeling and, more particularly, to the computerized simulation and modeling of virtual clothing articles on a virtual body representation, wherein the virtual body representation possesses certain physical attributes of a human consumer.

2. Brief Description of the Prior Art

Transactions involving the buying and selling of merchandise over the Internet, sometimes referred to as e-commerce transactions, have increased substantially in the past decade. In a typical transaction, a merchant develops a web page that contains virtual visual images of various goods or services. A prospective consumer accesses the website via a computer and Internet connection, views the virtual visual images of the various goods and services, selects any number of items to be purchased by placing a mouse pointer on the item and clicking the appropriate mouse button, and pays for the items using a credit card, debit card, or some other accepted payment method.

The explosion of e-commerce transactions has provided an entirely new medium for those in wholesale and retail sales. However, sometimes the way goods appear in a catalog or on a computer monitor is not necessarily the way the goods look in the driveway, living room, or closet of a consumer.

In the multi-billion dollar per annum clothing and apparel industry, consumer satisfaction is a risky proposition, since not every clothing item looks the same on both a consumer and a fashion model and sizes can fluctuate between different manufactures of apparel. Due in part to the costs associated with guaranteed return shipping, as well as advantages inherent in the computer age, clothing manufactures, and suppliers began to create computerized simulation and modeling software programs which allow a consumer to select a computer generated virtual body representation that closely matches their own body representation and view different sizes of virtual clothing articles on the virtual body. In effect, these apparel sizing computer simulation and modeling software programs allow a consumer to dress a virtual representation of their own body representation, visually inspect how different representations or sizes of virtual clothing articles fit the virtual representation, and more closely estimate how real clothes will look when actually worn.

The current state of the art in virtual apparel and body simulation is based on discrete approximations of both the continuous, not only C0 but also C1, apparel and body. Further, time is continuous; however, for the purposes of simulation, time is treated in discrete parts. To affect the passage of time in a simulation, numerical integration is used. The particular numerical integrator may vary; however, all systems are based on the use of numerical integration (Forward Euler, Reverse Euler, 4^{th} order Runge Kutta, etc.).

As with most representations used for modeling, apparel sizing modeling and simulation software can produce less than realistic results in certain situations. One common problem in apparel sizing modeling and simulation is gravitational distortion of a virtual clothing article. For example, when a consumer selects a virtual clothing article which covers the torso and surrounds the neck of a virtual body representation, the neck edge of the virtual clothing article may be distorted because the simulation software approximates the mass of an actual clothing article, applies simulated gravity to the approximated mass, and calculates a normal force (a force represented mathematically by a vector pointing towards the center of the Earth, away from the virtual clothing article) of sufficient magnitude to cause a visual deformation or sagging of the neck region of the virtual clothing article. Moreover, the normal force may be so great that the shoulders are bared when the virtual clothing article is placed onto the virtual body representation or when the virtual body representation is animated to simulate side-to-side movement, slouching, or other movements of the human body.

Another problem is proper positioning of the virtual clothing article. As a real world analogy, when a child puts on a shirt, the shirt is very seldom immediately symmetric about an imaginary axis that runs longitudinally through the head and feet of the child and bisects the child into two equal sections when the child is viewed from the front. Therefore, the parent usually needs to rearrange the shirt on the child to achieve an acceptable degree of symmetry. Other instances of positioning issues may occur at the waist, wrist, or any other area where there is a commonly understood correct position for the virtual clothing article relative to a body. The same non-symmetric phenomenon occurs during apparel sizing computer simulation and modeling, and corrective action is generally accomplished by manually adjusting the virtual clothing article via a computer mouse and a 3D modeling program, such as a CAD package. This is time consuming, and somewhat irritating.

Another problem in current simulation techniques for virtual garments on virtual bodies is caused by the fact that they are all based on discretized approximations of both a real garment and a real body. These approximations are not mathematically continuous in the first derivative and, therefore, are connected but not smooth. This lack of first derivative continuity is a rather bothersome issue and causes the discrete representations to interact with one another in ways which would not occur in reality. One specific side effect of the discretized representation is that the virtual garment may snag on the virtual body and not allow the simulated system to represent the reality of a continuous garment and continuous body.

The problems in the prior art render simulation technologies for virtual garments on virtual bodies valueless to the consumer, since there can only be a very low confidence in the accuracy of any information presented to the consumer.

### SUMMARY OF THE PRESENT INVENTION

In an effort to help solve the problems associated with the known prior art, the present invention includes a method to correct the visual appearance of a virtual clothing article positioned on a virtual body representation including the steps of (a) providing a virtual body representation; (b) providing a virtual clothing article constructed from a simulated material; (c) simulating drape behavior of the virtual clothing article on the virtual body representation; and (d) automatically correcting the visual appearance of the virtual clothing article so that the virtual clothing article accurately resembles what an actual clothing article would look like when placed on a real person having an actual body type that corresponds to the virtual body representation. The step of automatically correcting the visual appearance of the virtual clothing article so that the virtual clothing article accurately resembles what an actual clothing article would look like when positioned on a real person having an actual body type that corresponds to the virtual body representation may include the step of: (e) automatically correcting for exaggerated gravitational distortion of the virtual clothing article. The step of automatically correcting for exaggerated gravitational distortion of the virtual clothing article may be accomplished by the steps of (f) selecting a chord in the virtual clothing article; and (g) mathematically strengthening the chord. The step of mathematically strengthening the chord may be accomplished by the steps of (g) expressing the chord mathematically as F′(x) =(Kₛ*S₁*X)−(K_{d}*sqrt(S₂)*V); (h) adjusting the value of constant S₁ according to physical properties of the simulated material of the virtual clothing article; and (i) adjusting the value of constant S₂ according to physical properties of the simulated material of the virtual clothing article.

The step of automatically correcting the visual appearance of the virtual clothing article so that the virtual clothing article accurately resembles what an actual clothing article would look like when placed on a real person having an actual body type that corresponds to the virtual body representation may also generally include the steps of: (a) identifying a body reference point on the virtual body representation; (b) identifying an article reference point on the virtual clothing article; (c) comparing the body reference point to the article reference point; and (d) applying a mathematical force to the virtual clothing article so that the article reference point is substantially aligned or in some cases coincident with the body reference point.

The step of identifying a body reference point on the virtual body representation may in the case of centering a virtual shirt or virtual dress include the steps of (e) identifying a left shoulder point and a right shoulder point on the virtual body representation; (f) identifying a neck point at a center of the neck of a virtual body representation; (g) constructing a left shoulder vector that extends between the left shoulder point and the neck point; (h) constructing a right shoulder vector that extends between the right shoulder point and the neck point; (i) constructing a left shoulder cylinder that has a radius R₁ and extends longitudinally along the left shoulder vector; (j) constructing a right shoulder cylinder that has a radius R₂ and extends longitudinally along the right shoulder vector; and (k) constructing a shoulder-to-shoulder line segment that extends between the left shoulder point and the right shoulder point. The step of identifying an article reference point on the virtual clothing article which is to have its position automatically adjusted about the neck may include the steps of (l) projecting mass points on a neck edge of the virtual clothing article onto the shoulder-to-shoulder line segment; (m) picking N number of mass points that are furthest in distance from the left shoulder vector along the shoulder-to-shoulder line segment; (n) computing a center of each of the N number of points and identifying the resultant quantity as a right neck center; (o) picking M number of points that are furthest in distance from the right shoulder vector along the shoulder-to-shoulder line segment; (p) defining a right distance as the distance from the right neck center to the neck point; (q) computing a center of each M number of points and identifying the resultant quantity as a left neck center; (r) evaluating the right distance and left distance to determine the position of the virtual clothing article relative to the virtual body representation; and (s) applying a mathematical force to the virtual clothing article so that a mathematical difference between the right distance and the left distance is equal, or within a predetermined error factor.

The step of identifying a body reference point on a virtual body representation may in the case of a pair of pants or a skirt include the steps of (a) identifying a waist point on the virtual body such that the point is contained within the virtual body at the location of the waist, and (b) a vector which points from the feet of the virtual model to the head of the virtual model.

An apparatus to correct a visual appearance of a virtual clothing article positioned on a virtual body representation is also provided and includes computer means to generate the virtual clothing article and the virtual body representation; means to automatically correct for exaggerated gravitational distortion of the virtual clothing article; and means to automatically center a virtual clothing article on a virtual body representation.

The present invention helps to provide a more accurate visual representation of what a virtual clothing article will look like when a real corresponding clothing article is worn by an actual person. Moreover, the present invention helps to save time and money by automatically positioning a virtual clothing article on a virtual body representation.

### BRIEF DESCRIPTION OF THE DRAWINGS

FIG. 1 is a front view of computing means and virtual clothing article superimposed on a virtual body representation;

FIG. 1A is an exploded view of a portion of the virtual clothing article and virtual body representation shown in FIG. 1;

FIG. 1B is another exploded view of the portion of the virtual clothing article and virtual body representation shown in FIG. 1A; and

FIG. 2 is a rear view of a virtual clothing article superimposed on a virtual body representation.

### DETAILED DESCRIPTION OF THE PREFERRED EMBODIMENTS

In general, the present invention is directed to a method and apparatus for automatically compensating for fit errors in apparel simulation and modeling software programs. More particularly, gravitational distortion of a virtual clothing article is preferably resolved by selecting a specific chord or chords in the virtual clothing article and mathematically strengthening the selected chord or chords.

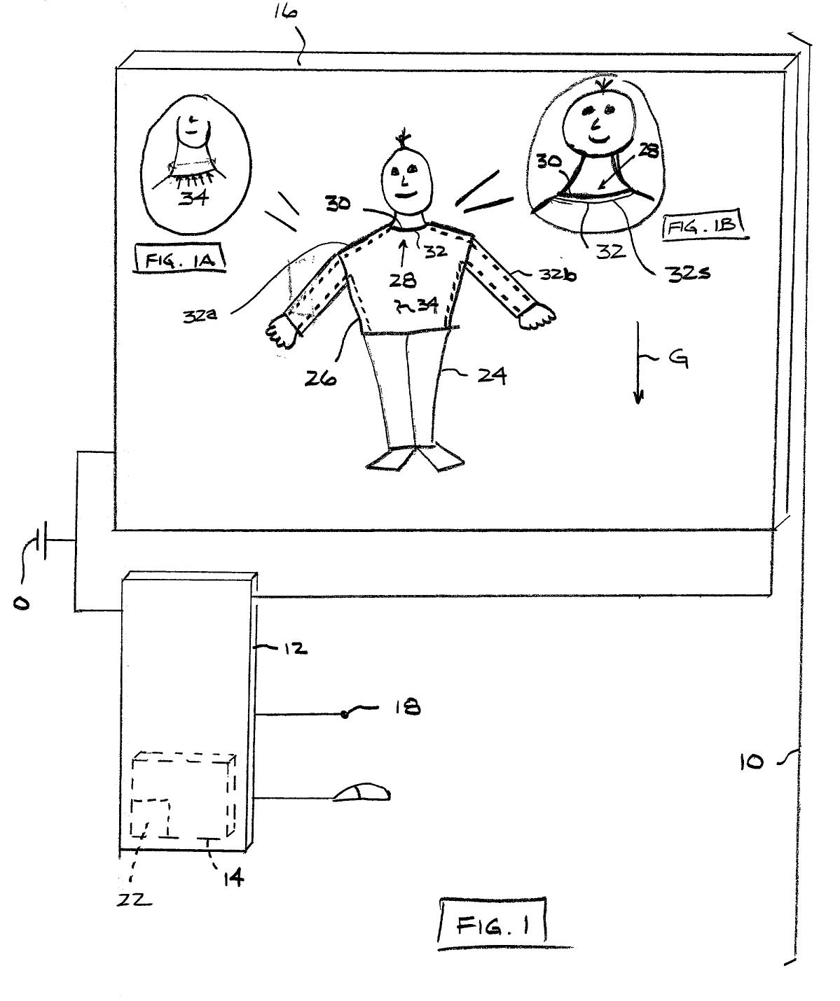

For example, FIG. 1 shows computing means 10 that generally includes a computer 12 having a CPU 14 (such as those commercially available from INTEL, AMD, or other commercial manufacturer of motherboards or computer CPUs), a computer monitor 16 (such as a cathode ray tube or other suitable display device), an Internet connection 18 (such as a cable modem, telephone modem, T1 line, T3 line, or other suitable connection), a power source 20 (such as 120/220 volt AC or other suitable DC source), apparel simulation and modeling software 22 executed by the CPU 14, a virtual body representation 24 displayed on the computer monitor 16, and a virtual clothing article 26 superimposed on the virtual body representation 24.

Gravitational distortion caused by the effects of simulated gravity G on the virtual clothing article 26 can be exaggerated in and around a neck area 28 of the virtual clothing article 26. This gravitational distortion can be reduced by the present invention by first identifying a neck line 30 of the virtual clothing article 26. This step is accomplished by finding all of the open edges 34 (FIG. 1A) in the vicinity of the neck area 28 of the virtual clothing article 26. In this embodiment a polygonal mesh is employed, and an open edge is only a portion of one polygon.

Once all of the open edges are found, the next step is defining a chord 32 which in the application of this technique to the neck line 30 of the virtual clothing article 26 is composed of the sequence of open edges which make up a neck hole. As defined herein, chord 32 is a mathematical line or curve. After the chord 32 is defined, the next step is traversing the chord 32 along the identified open edges 34 in the neck area 28 of the virtual clothing article 26. The exploded portion of FIG. 1 shows the chord 32 spaced away from the open edges 34 of the virtual clothing article 26, but in practice the chord 32 preferably lies substantially coincident with the neck line 30 defined by the open edges 34 of the virtual clothing article 26. The next preferred step is artificially and automatically strengthening the chord 32 (to form strengthened chord 32s shown in FIG. 1B) through modification of the spring force function, F(x), that would otherwise mathematically represent the chord 32. The classic spring force function is expressed mathematically as:

F(x)=(Kₛ*X)−(K_{d}*V) (1)

Where:

Kₛ=spring force constant

X=current length−rest length

K_{d}=spring damping constant

V=current velocity projected onto the spring

In the preferred embodiment of the present invention, the classic spring force function that mathematically represents the chord 32 is modified by scaling values, and is expressed mathematically as:

F′(x)=(Kₛ*S₁X)−(K_{d}*S₂*V) (2)

Where:

Kₛ=spring force constant

S₁=spring scaling value>1

X=current length−rest length

K_{d}=spring damping constant

S₂=approximately the square root of S1

V=current velocity projected onto the spring

The choice of S₁ and S₂ depend on the material of the virtual clothing article. For example, since silk is a lightweight fabric, the value of S₁ and S₂ could each be one, depending on the overall size of the virtual clothing article. Heavy simulated fabrics, such as leather or wool, may have an S₂ value of two and an S₂ value of two. Again, the actual S₁ and S₂ values further depend on the overall size of the virtual clothing article 26. In any case, a remaining body 34 of the virtual clothing article 26 is not changed, but the identified chord 32 is modified to be a mathematically strengthened chord 32s.

In practical terms, the strengthened chord 32s positioned adjacent to the neck line 30 virtual clothing article 26 is analogous to a stiffened bar. The remainder 34 of the of the virtual clothing article 26 acts much like a plurality of springs, wherein one end of each spring is attached to the bar and the other end of the spring is attached to a mass. As gravity acts on the individual masses and the individual springs, the springs expand but the stiffened bar only flexes within pre-defined limits. Likewise, the mathematically strengthened chord 32s is substantially more resistant to deformation than the remainder 34 of the virtual clothing article 26 which is subject to the classic, unaltered, spring force function.

It should be noted that modification of the spring force function, F(x), to mathematically strengthen a pre-selected chord 32 is not limited to correction of the neck area 28 of the virtual clothing article 26. As shown in FIG. 1, a chord 32a may also be selected along a shoulder seam or a sleeve crease 32b of the virtual clothing article 26. By strengthening these chords 32a, 32b, sleeve length will not be exaggerated, but the simulated material that makes up the remainder 34 of virtual clothing article 26 will otherwise stretch or constrict when an imaginary arm extending through the sleeve is bent, raised, or lowered.

In addition to correcting disproportionate neck stretching, a method of automatically attaining and maintaining a position for a virtual clothing article on a virtual body representation is also provided. In general, the method includes the steps of identifying a body reference point on a virtual body representation, identifying an article reference point on a virtual clothing article, positioning the virtual clothing article on the virtual body representation, comparing the body reference point to the article reference point, and applying a mathematical force to the virtual clothing article so that the article reference point is substantially coincident or aligned with a function of the body reference point.

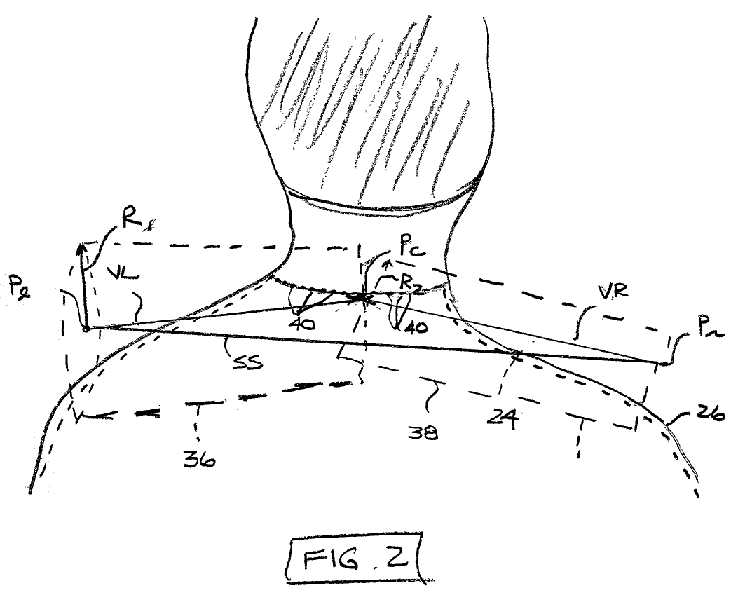

More specifically, as in the case of centering a virtual clothing article about the neck of a virtual body, as shown in FIG. 2, reference points Pₗ and Pᵣ represent, respectfully, the left shoulder point and right shoulder points on the virtual body representation 24 and point P_{c} is defined as a point at the center of a neck line 30 of a virtual clothing article 26. Using the aforementioned reference points, various vectors are constructed. In particular, a left shoulder vector VL extends between points Pₗ to P_{c} and a right shoulder vector VR extends between points Pᵣ to P_{c}. A left shoulder cylinder 36 is constructed, with the left shoulder cylinder 36 having a radius R₁ and extending longitudinally along the left shoulder vector VL. A right shoulder cylinder 38 has a radius R₂ and extends longitudinally along the right shoulder vector VR. A shoulder-to-shoulder SS line segment extends between points Pₗ and Pᵣ.

Using these reference points and cylinders, the next step is projecting mass points 40 on the neck line 30 of the virtual clothing article 26 onto the shoulder-to-shoulder SS line segment. The next step is picking an N number of mass points that are on the neck line 30 of the virtual clothing article 26 and furthest from point Pₗ along the shoulder-to-shoulder SS line segment and an M number of mass points that are on the neck line 30 of the virtual clothing article 26 and furthest from point Pᵣ along the shoulder-to-shoulder SS line segment. N and M are small positive integers, usually 1, 2, or 3; however, in theory, any 1≧N (or M) ≧number of masspoints/2 on the neck edge of the virtual clothing article will work.

The next preferred step is to identify all mass points of the virtual clothing article 26 that are contained within the right shoulder cylinder 38. These points are called the right shoulder group. The next step is to identify all mass points of the virtual clothing article 26 that are contained within the left shoulder cylinder 36. The points are called the left shoulder group.

The next preferred step is computing the center of each of the N number of mass points. This quantity is defined as a right neck center. The following step is computing the center of each of the M number of mass points. This quantity is defined as a left neck center. The next steps are defining a right distance as the cartesian distance from the right neck center to point P_{c} and defining a left distance as the cartesian distance from the left neck center to point P_{c}.

The next step is evaluating the right distance and left distance to determine the position of the virtual clothing article relative to the virtual body representation. The following algorithm may be used to provide an automated correcting step that centers the virtual clothing article:

if(|right distance−left distance|<ε)

with

ε=as a predetermined error distance approximately equal to zero

then the virtual clothing article is centered about the neck region of the virtual body representation;

else if (right Distance>left Distance)

then the virtual clothing article is off center to the right side of the body,

apply a simulated force to all mass points contained within the right shoulder group along the right shoulder vector toward point P_{c},

apply force to all mass points contained in the left shoulder group along the left shoulder vector moving the virtual clothing article toward Pₗ;

else if (Left Distance>Right Distance)

then the virtual clothing article is off center to the left side of the body

apply a simulated force to all mass points contained within the left shoulder group along the left shoulder vector toward point P_{c},

apply force to all mass points contained in the right shoulder group along the right shoulder vector moving the virtual clothing article toward Pᵣ.

The algorithm above compares the position of the virtual clothing article with the virtual body representation and applies forces to the virtual clothing article so as to reposition it into a central position with respect to point P_{c}. The comparisons are done in each finite analysis frame and the resultant forces are applied in each passage of discrete time so as to attain and maintain the correct position of the virtual clothing article. The aforementioned process can be used to apply forces to move a virtual clothing article in any direction, including longitudinally, with respect to the virtual body representation, or even move the article in a cylindrical field instead of a cartesian field.

Finally, in a last aspect of the present invention, because the virtual models for the garment and the body are polygonal (usually triangles), there will be non-realistic interpenetration of the garment polygons into the body polygons. This occurs because the polygons which comprise the virtual models of the garment and body are not treated as solid surfaces, but are treated as a connected lattice of edges. This means that two triangles may, and often will, interpenetrate one another in a non-realistic fashion without being able to pass though. This may cause an interaction problem between the virtual clothing article and the virtual body representation. A standard response to detected interpenetration of primitives, is to relocate the primitives to the last known non-intersection position. Due to this simple strategy, in discrete time simulation, it is not uncommon to reach a situation in which the virtual garment “sticks” to the body because each analysis frame, or discrete passage of time, repeats exactly the same action as the one before it. To solve this problem, when a collision is detected between a part of the virtual clothing article and a portion of the virtual body representation, all of the virtual body representation triangles involved in the collision are identified. For each virtual clothing article triangle, the applicable virtual body representation triangles are recorded. The next time that any velocity vector computation is made for any point in any virtual clothing article triangle involved in a collision, any force component which is in the direction of the surface normal of any virtual body representation triangle which it intersected in the last analysis frame is removed. In other words, if a virtual clothing article triangle hit the virtual body representation earlier in time, the virtual body triangle is probably still in the same location. If in this analysis frame we try to move in the same direction, we will make no progress toward an acceptable state. Moving in the same direction will likely cause another collision, so any force which could cause collision movement is canceled. This line of thought is simply applied to each triangle in the virtual clothing article. The idea is to allow the virtual clothing article polygons to “float” over the part of the virtual body representation that the virtual clothing article triangle hit during the last analysis frame. This concept works in static force fields (gravity) and also variable intensity fields.

We claim:

1. A method to correct a visual appearance of a virtual clothing article positioned on a virtual body representation by computer simulation comprising the steps of:
(a) providing a virtual body representation;
(b) providing a virtual clothing article constructed from a simulated material;
(c) simulating drape behavior of the virtual clothing article on the virtual body representation; and
(d) automatically correcting the visual appearance of the virtual clothing article through the addition of force vectors so that the virtual clothing article accurately resembles what an actual clothing article would look like when placed on a real person having an actual body type that corresponds to the virtual body representation.

2. The method as claimed in claim 1, wherein the step of automatically correcting the visual appearance of the virtual clothing article so that the virtual clothing article accurately resembles what an actual clothing article would look like when placed on a real person having an actual body type that corresponds to the virtual body representation includes the step of:
(e) automatically correcting for exaggerated gravitational distortion of the virtual clothing article.

3. The method as claimed in claim 2, wherein the step of automatically correcting for exaggerated gravitational distortion of the virtual clothing article is accomplished by the steps comprising:
(f) selecting a chord in the virtual clothing article; and
(g) mathematically strengthening the chord.

4. The method as claimed in claim 3, wherein the step of mathematically strengthening the chord is accomplished by the steps comprising:
(h) expressing the chord mathematically as
F′(x)=(Kₛ*S₁X)−(K_{d}*sqrt(S₂)V);
(i) adjusting the value of constant S₁ according to physical properties of the simulated material of the virtual clothing article; and
(j) adjusting the value of constant S₂ according to physical properties of the simulated material of the virtual clothing article.

5. The method as claimed in claim 1, wherein the step of automatically correcting the visual appearance of the virtual clothing article so that the virtual clothing article accurately resembles what an actual clothing article would look like when placed on a real person having an actual body type that corresponds to the virtual body representation is accomplished by the steps comprising:
(a) identifying a body reference point or set of points on the virtual body representation;
(b) identifying an article reference point or set of points on the virtual clothing article;
(c) comparing the body reference point or points to the article reference point or points;
(d) applying a mathematical force to the virtual clothing article so that the article reference point is substantially coincident or aligned with the body reference point or a mathematical function thereof.

6. The method as claimed in claim 5, wherein the step of identifying a body reference point on the virtual body representation includes the steps comprising:
(e) identifying a left shoulder point and a right shoulder point on the virtual body representation;
(f) identifying a neck point at a center of the neck of a virtual body representation;
(g) constructing a left shoulder vector that extends between the left shoulder point and the neck point;
(h) constructing a right shoulder vector that extends between the right shoulder point and the neck point;
(i) constructing a left shoulder cylinder that has a radius R₁ and extends longitudinally along the left shoulder vector;
(j) constructing a right shoulder cylinder that has a radius R₂ and extends longitudinally along the right shoulder vector; and
(k) constructing a shoulder-to-shoulder line segment that extends between the left shoulder point and the right shoulder point.

7. The method as claimed in claim 6, wherein the step of identifying an article reference point on the virtual clothing article includes the step comprising:
(l) projecting mass points on a neck edge of the virtual clothing article onto the shoulder-to-shoulder line segment.

8. The method as claimed in claim 7, further comprising the steps of:
(m) picking N number of mass points that are furthest in distance from the left shoulder vector along the shoulder-to-shoulder line segment;
(n) computing a center of each of the N number of points and identifying the resultant quantity as a right neck center;
(o) picking M number of points that are furthest in distance from the right shoulder vector along the shoulder-to-shoulder line segment;
(p) defining a right distance as the distance from the right neck center to the neck point;
(q) computing a center of each M number of points and identifying the resultant quantity as a left neck center;
(r) evaluating the right distance and left distance to determine the position of the virtual clothing article relative to the virtual body representation; and
(s) applying a mathematical force to the virtual clothing article so that a mathematical difference between the right distance and the left distance is equal, or within a predetermined error factor.

9. An apparatus to correct a visual appearance of a virtual clothing article positioned on a virtual body representation comprising:
computer means to generate the virtual clothing article and the virtual body representation;
means to automatically correct for exaggerated gravitational distortion of the virtual clothing article; and
means to automatically position a virtual clothing article on a virtual body representation.

10. The method as claimed in claim 1, wherein the step of automatically correcting the visual appearance of the virtual clothing so that the virtual clothing article accurately resembles what an actual clothing article would look like when placed on a real person having an actual body type that corresponds to the virtual body representation is comprised of the steps:
(a) identifying each virtual body polygon which intersects the virtual garment polygon in an analytical time frame;
(b) repositioning the virtual garment polygon to the last place in space and time where it did not intersect any of the virtual body polygons;
(c) computing the force applied to each mass point in the virtual garment and removing a linear combination of force components of the aggregate force vector for a mass point which would, if not removed, move it along the face normal of any virtual body polygon which intersected an attached virtual garment polygon in the last analysis frame.
